(19) United States
(12) Patent Application Publication
(10) Pub. No.: US 2022/0398746 A1
(43) Pub. Date: Dec. 15, 2022

(54) LEARNING METHOD AND DEVICE FOR VISUAL ODOMETRY BASED ON ORB FEATURE OF IMAGE SEQUENCE

(71) Applicant: Beijing Moviebook Science and Technology Co., Ltd., Beijing (CN)

(72) Inventor: Ying FU, Beijing (CN)

(73) Assignee: Beijing Moviebook Science and Technology Co., Ltd., Beijing (CN)

(21) Appl. No.: 17/778,414

(22) PCT Filed: Nov. 19, 2020
(86) PCT No.: PCT/CN2020/130052

§ 371 Date: May 20, 2022

(30) Foreign Application Priority Data
Nov. 20, 2019 (CN) 201911144014.X

(51) Int. Cl. G06T 7/246; G06T 7/269; G06T 7/593; G06T 7/285

(52) U.S. Cl. CPC G06T 7/246; G06T 7/269; G06T 7/593; G06T 7/285; G06T 2207/30244; G06T 2207/20081; G06T 2207/10021

(57) ABSTRACT

A learning method and a learning device for visual odometry based on an ORB feature of an image sequence are provided. The learning method includes: recording images, and constituting an original data set by means of the plurality of obtained images; performing ORB feature extraction on the images in the original data set to realize extraction of first key features; performing feature extraction and matching on continuous images in the original data set by means of a convolutional neural network, and extracting rich second key features from the sequential images; and inputting the first key features and the second key features extracted from the original data set into a multi-layer long-short-term memory network for training and learning, and generating and outputting estimation of a visual odometer. Rich first key features are extracted from an image sequence, and then a tracking algorithm is used for tracking the features in continuous frames.

### CROSS REFERENCE TO THE RELATED APPLICATIONS

This application is the national phase entry of International Application No. PCT/CN2020/130052, filed on Nov. 19, 2020, which is based upon and claims priority to Chinese Patent Application No. 201911144014.X, filed on Nov. 20, 2019, the entire contents of which are incorporated herein by reference.

### TECHNICAL FIELD

The present disclosure relates to the technical field of trajectory ranging, and in particular to, a learning method and a learning device for visual odometry based on an ORB feature of an image sequence.

### BACKGROUND

Visual odometry (VO) is a process of gradually estimating a pose of a vehicle based on changes in an image caused by a motion of an on-board camera or a mobile robot. Visual odometry is an important Simultaneous Localization and Mapping (SLAM) feature that relies on vision sensors to measure a trajectory of a moving object from several adjacent images. However, visual odometry only cares about the motion in local time, and usually it refers to the motion between two time instants. When the time is sampled at a certain interval, the motion of the object within each time interval may be estimated. However, the estimation is affected by noise. Once there is an error in the estimation for the previous time instant, the error will be accumulated in the subsequent motion. This situation is called drift and is an important indicator for evaluating slam. The main methods of visual odometry include a feature point method and a direct method. The feature point method is more mainstream and may be used in a case that the noise is large and the camera moves fast.

An existing visual odometry method combined with deep learning, such as the monocular visual odometry (UnDeepVO) based on unsupervised deep learning, has following two prominent features. One feature is that an unsupervised deep learning strategy is used. The other feature is that an absolute scale can be calculated. UnDeepVO is a monocular SLAM system that uses continuous monocular images for testing. However, during training, the scale obtained from the stereo image pair is inputted to UnDeepVO to train UnDeepVO. The loss function is defined based on dense data of space and time. The model includes a pose estimator and a depth estimator, whose inputs are both continuous monocular images, and output 6-DoF pose value and depth value respectively. The pose estimator is a VGG-based convolutional neural network, two sequences of monocular images are inputted to the pose estimator to predict 6-DOF transition between the monocular images. The translation parameter and rotation parameter are separated by two separate sets with fully connected layers after the last convolutional layer. Weights are introduced to normalize rotation and translation, to leading to a better predicted value. The depth estimator is mainly to obtain a dense depth map based on encoding-decoding. The depth estimation method using image disparity (inverse depth) are trained by directly predicting the depth map.

These current methods cannot regress odometry in an efficient manner, and average drift results are not good enough in addressing visual drift.

### SUMMARY

The purpose of the present disclosure is to overcome the above-mentioned problems or at least partially solve or alleviate the above-mentioned problems.

According to an aspect of the disclosure, a learning method for visual odometry based on an ORB feature of an image sequence is provided. The learning method includes: acquiring multiple images and forming an original data set based on the multiple images; performing ORB feature extraction on each of the images in the original data set, to extract a first key feature; performing feature extraction and feature matching on consecutive images in the original data set through a convolutional neural network, to extract a rich second key feature from the consecutive images; inputting the first key feature and the second key feature extracted from the original data set to a stacked multi-layer long short-term memory for training and learning, to generate and output estimation for the visual odometry.

Preferably, the performing ORB feature extraction on each of the images in the original data set, to extract a first key feature includes: detecting a key point in an input image by using a FAST algorithm, to generate a FAST feature point; selecting multiple points from the image according to a Harris corner detection operator; improving noise resistance and rotation invariance by using a Brief descriptor generation algorithm; arranging the images in the original data set according to time stamps, and extracting the first key feature from consecutive key frames in the arranged images through an ORB detector.

Preferably, the learning method further including: after the first key feature is extracted from the arranged images, observing a process of the ORB feature extraction by using Lucas-Kanade optical flow, to obtain the first key feature that conforms to the key point of the image by screening.

Preferably, the acquiring multiple images and forming an original data set based on the multiple images includes: simultaneously acquiring a to-be-observed image by two cameras; pairing the images acquired by the two cameras according to acquiring time instants; and arranging the paired images according to the acquiring time instants, to form the original data set.

Preferably, a downward convolution layer of a FlowNetCorr-like structure is used as an architecture of the convolutional neural network, and the performing feature extraction and feature matching on consecutive images in the original data set through a convolutional neural network, to extract a rich second key feature from the consecutive images includes: inputting each of a pair of images in the original data set to the convolution layer to extract a respective feature; matching the features of the pair of images and continuously extracting motion information from the consecutive images, to extract the second key feature.

Preferably, the multi-layer long short-term memory includes multiple LSTM layers, each LSTM layer is provided with a forget gate, a bias parameter of the forget gate is randomly initialized, an activation function used in each LSTM layer is a linear activation function, each LSTM layer further includes a storage unit for preventing gradients from disappearing, and the inputting the first key feature and the second key feature extracted from the original data set to a stacked multi-layer long short-term memory for training and learning, to generate and output estimation for the visual odometry includes: synthesizing the first key feature and the second key feature, and predicting pose information in a current state based on pose information in a previous state, to generate the estimation for the visual odometry.

According to another aspect of the disclosure, a learning device for visual odometry based on an ORB feature of an image sequence is provided. The learning device includes: an image acquiring module, configured to acquire multiple images by using a camera and form an original data set based on the multiple images; an ORB feature extraction module, configured to perform ORB feature extraction on each of the images in the original data set, to extract a first key feature; a convolutional neural network training module, configured to perform feature extraction and feature matching on consecutive images in the original data set through a convolutional neural network, to extract a rich second key feature from the consecutive images; a long short-term memory training module, configured to input the first key feature and the second key feature extracted from the original data set to a stacked multi-layer long short-term memory for training and learning, to generate and output estimation for the visual odometry.

Preferably, the ORB feature extraction module being configured to perform ORB feature extraction on each of the images in the original data set, to extract a first key feature includes the ORB feature extraction module being configured to: detect a key point in an input image by using a FAST algorithm, to generate a FAST feature point; select multiple points from the image according to a Harris corner detection operator; improve noise resistance and rotation invariance by using a Brief descriptor generation algorithm; arrange the images in the original data set according to time stamps, and extract the first key feature from consecutive key frames in the arranged images through an ORB detector; and after the first key feature is extracted from the arranged images, observe a process of the ORB feature extraction by using Lucas-Kanade optical flow, to obtain the first key feature that conforms to the key point of the image by screening.

Preferably, the image acquiring module is provided with two cameras having the same image acquiring mechanism, the image acquiring module is configured to: pair images acquired by the two cameras according to acquiring time instants; and arrange the paired images according to the acquiring time instants, to form the original data set; and a downward convolution layer of a FlowNetCorr-like structure is used as an architecture of the convolutional neural network, and the convolutional neural network training module being configured to perform feature extraction and feature matching on consecutive images in the original data set through a convolutional neural network to extract a rich second key feature from the consecutive images includes the convolutional neural network training module being configured to: input each of a pair of images in the original data set to the convolution layer to extract a respective feature; and match the features of the pair of images and continuously extracting motion information from the consecutive images, to extract the second key feature.

Preferably, the multi-layer long short-term memory includes multiple LSTM layers, each LSTM layer is provided with a forget gate, a bias parameter of the forget gate is randomly initialized, an activation function used in each LSTM layer is a linear activation function, each LSTM layer further includes a storage unit for preventing gradients from disappearing, and the long short-term memory training module being configured to input the first key feature and the second key feature extracted from the original data set to a stacked multi-layer long short-term memory for training and learning to generate and output estimation for the visual odometry includes the long short-term memory training module being configured to: synthesize the first key feature and the second key feature, and predict pose information in a current state based on pose information in a previous state, to generate the estimation for the visual odometry.

According to another aspect of the present disclosure, a computing device is provided. The computing device includes a memory, a processor, and a computer program stored in the memory and executable by the processor. The processor executes the computer program to perform the method described above.

According to another aspect of the present disclosure, a computer-readable storage medium is provided. The medium is preferably a non-volatile readable storage medium. The medium stores a computer program. The computer program, when executed by a processor, performs the method described above.

According to another aspect of the present disclosure, a computer program product is provided. The computer program product includes computer readable code which, when executed by a computer device, causes the computer device to perform the method described above.

According to the technical solution provided by this disclosure, rich features can be extracted from a consecutive image sequence, and then be tracked with inputting the feature of a key frame queue, and the dimension of the input feature is reduced by selecting a suitable convolutional neural network architecture, motion information is extracted and outputted to a multi-layer long short-term memory for training, to estimate the visual odometry and output the pose estimation of a moving object.

The above and other objects, advantages and features of the present disclosure will be more apparent to those skilled in the art from the following detailed description of the specific embodiments of the present disclosure in conjunction with the accompanying drawings.

### BRIEF DESCRIPTION OF THE DRAWINGS

Hereinafter, some specific embodiments of the present disclosure will be described in detail by way of example and not limitation with reference to the accompanying drawings. The same reference numbers in the drawings designate the same or similar components or parts. It will be understood by those skilled in the art that the drawings are not necessarily to scale. In the drawing:

FIG. 1 is a flowchart of a learning method for visual odometry based on an ORB feature of an image sequence according to an embodiment of the present disclosure;

FIG. 2 is a structural diagram of a learning device for visual odometry based on an ORB feature of an image sequence according to an embodiment of the present disclosure;

FIG. 3 is a structural diagram of a computing device according to an embodiment of the present disclosure; and

FIG. 4 is a structural diagram of a computer-readable storage medium according to an embodiment of the present disclosure.

### DETAILED DESCRIPTION OF THE EMBODIMENTS

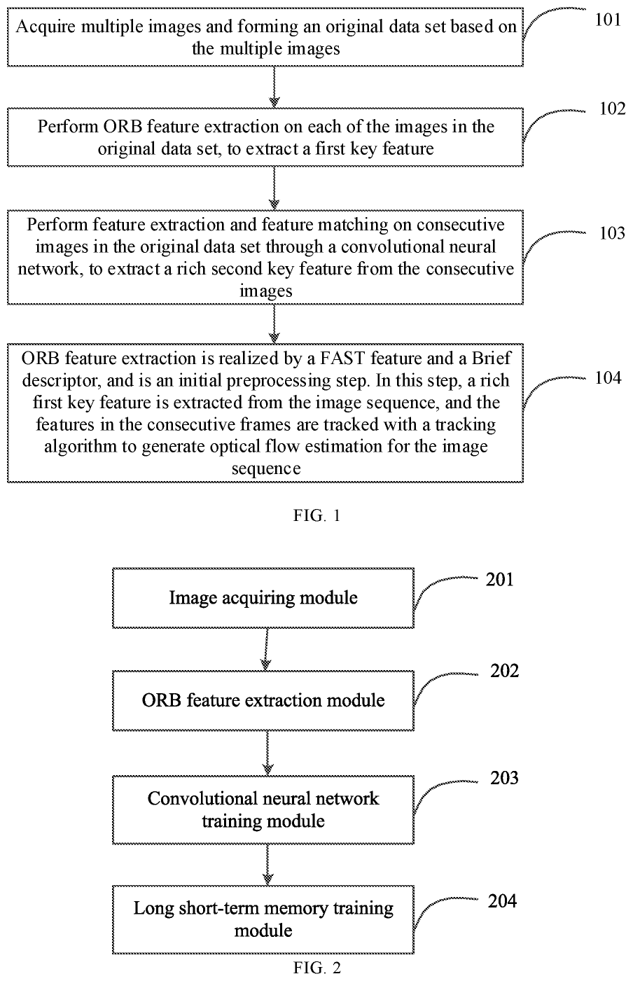

FIG. 1 is a flowchart of a learning method for visual odometry based on an ORB feature of an image sequence according to an embodiment of the present disclosure. Referring to FIG. 1, the learning method for visual odometry based on an ORB feature of an image sequence includes steps 101 to 104.

Step 101, acquire multiple images and forming an original data set based on the multiple images.

Step 102, perform ORB feature extraction on each of the images in the original data set, to extract a first key feature.

Step 103, perform feature extraction and feature matching on consecutive images in the original data set through a convolutional neural network, to extract a rich second key feature from the consecutive images.

Step 104, input the first key feature and the second key feature extracted from the original data set to a stacked multi-layer long short-term memory for training and learning, to generate and output estimation for the visual odometry.

ORB feature extraction is realized by a FAST feature and a Brief descriptor, and is an initial preprocessing step. In this step, a rich first key feature is extracted from the image sequence, and the features in the consecutive frames are tracked with a tracking algorithm to generate optical flow estimation for the image sequence.

Specifically, a key point in an input image is detected by using a FAST algorithm, to generate a FAST feature point, multiple points are selected from the image according to a Harris corner detection operator, noise resistance and rotation invariance are improved by using a Brief descriptor generation algorithm, the images in the original data set are arranged according to time stamps, and the first key feature is extracted from consecutive key frames in the arranged images through an ORB detector. After the first key feature is extracted from the arranged images, a process of the ORB feature extraction is observed by using Lucas-Kanade optical flow, to obtain the first key feature that conforms to the key point of the image by screening.

Preferably, the acquiring multiple images and forming an original data set based on the multiple images includes: simultaneously acquiring a to-be-observed image by two cameras; pairing the images acquired by the two cameras according to acquiring time instants; and arranging the paired images according to the acquiring time instants, to form the original data set.

Preferably, a downward convolution layer of a FlowNetCorr-like structure is used as an architecture of the convolutional neural network. The performing feature extraction and feature matching on consecutive images in the original data set through a convolutional neural network, to extract a rich second key feature from the consecutive images includes: inputting each of a pair of images in the original data set to the convolution layer to extract a respective feature; matching the features of the pair of images and continuously extracting motion information from the consecutive images, to extract the second key feature.

Preferably, the multi-layer long short-term memory includes multiple LSTM layers, each LSTM layer is provided with a forget gate, a bias parameter of the forget gate is randomly initialized, an activation function used in each LSTM layer is a linear activation function, each LSTM layer further includes a storage unit for preventing gradients from disappearing. The inputting the first key feature and the second key feature extracted from the original data set to a stacked multi-layer long short-term memory for training and learning, to generate and output estimation for the visual odometry includes: synthesizing the first key feature and the second key feature, and predicting pose information in a current state based on pose information in a previous state, to generate the estimation for the visual odometry.

FIG. 2 is a structural diagram of a learning device for visual odometry based on an ORB feature of an image sequence according to an embodiment of the present disclosure. Referring to FIG. 2, the learning device for visual odometry based on an ORB feature of an image sequence includes: an image acquiring module 201, configured to acquire multiple images by using a camera and form an original data set based on the multiple images; an ORB feature extraction module 202, configured to perform ORB feature extraction on each of the images in the original data set, to extract a first key feature; a convolutional neural network training module 203, configured to perform feature extraction and feature matching on consecutive images in the original data set through a convolutional neural network, to extract a rich second key feature from the consecutive images; and a long short-term memory training module 204, configured to input the first key feature and the second key feature extracted from the original data set to a stacked multi-layer long short-term memory for training and learning, to generate and output estimation for the visual odometry.

Preferably, the ORB feature extraction module 202 being configured to perform ORB feature extraction on each of the images in the original data set, to extract a first key feature includes the ORB feature extraction module 202 being configured to: detect a key point in an input image by using a FAST algorithm, to generate a FAST feature point; select multiple points from the image according to a Harris corner detection operator; improve noise resistance and rotation invariance by using a Brief descriptor generation algorithm; arrange the images in the original data set according to time stamps, and extract the first key feature from consecutive key frames in the arranged images through an ORB detector; and after the first key feature is extracted from the arranged images, observe a process of the ORB feature extraction by using Lucas-Kanade optical flow, to obtain the first key feature that conforms to the key point of the image by screening.

Preferably, the image acquiring module 201 is provided with two cameras having the same image acquiring mechanism. The image acquiring module 201 is configured to: pair images acquired by the two cameras according to acquiring time instants; and arrange the paired images according to the acquiring time instants, to form the original data set. A downward convolution layer of a FlowNetCorr-like structure is used as an architecture of the convolutional neural network. The convolutional neural network training module 203 being configured to perform feature extraction and feature matching on consecutive images in the original data set through a convolutional neural network to extract a rich second key feature from the consecutive images includes the convolutional neural network training module 203 being configured to: input each of a pair of images in the original data set to the convolution layer to extract a respective feature; and match the features of the pair of images and continuously extracting motion information from the consecutive images, to extract the second key feature.

Preferably, the multi-layer long short-term memory includes multiple LSTM layers, each LSTM layer is provided with a forget gate, a bias parameter of the forget gate is randomly initialized, an activation function used in each LSTM layer is a linear activation function, each LSTM layer further includes a storage unit for preventing gradients from disappearing. The long short-term memory training module 204 being configured to input the first key feature and the second key feature extracted from the original data set to a stacked multi-layer long short-term memory for training and learning to generate and output estimation for the visual odometry includes the long short-term memory training module 204 being configured to: synthesize the first key feature and the second key feature, and predict pose information in a current state based on pose information in a previous state, to generate the estimation for the visual odometry.

The above and other objects, advantages and features of the present disclosure will be more apparent to those skilled in the art from the following detailed description of the specific embodiments of the present disclosure in conjunction with the accompanying drawings.

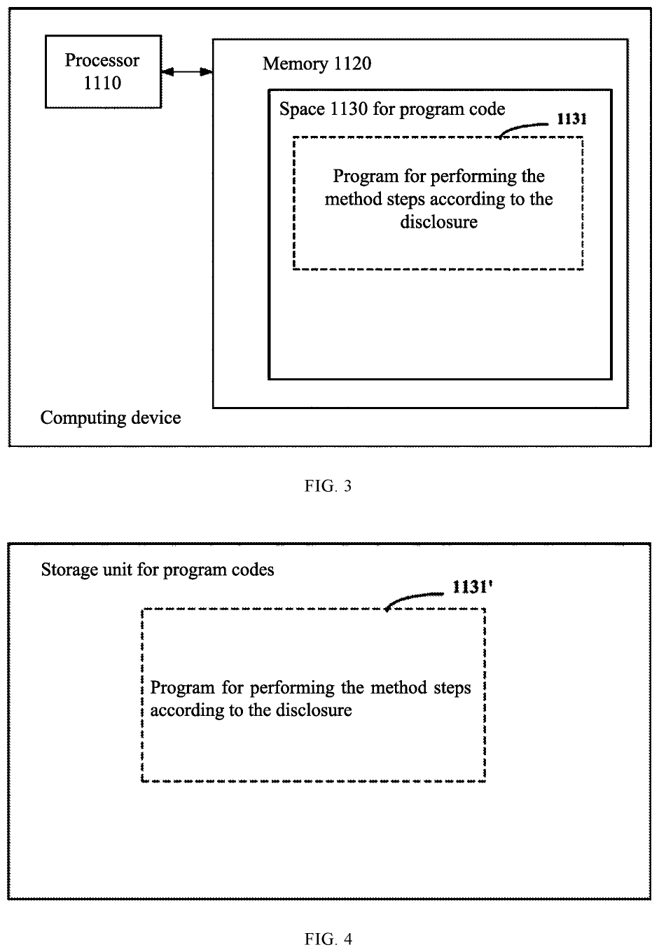

A computing device is provided according to an embodiment of the present disclosure. Referring to FIG. 3, the computing device includes a memory 1120, a processor 1110, and a computer program stored in the memory 1120 and executable by the processor 1110. The computer program is stored in a space 1130 for program code in the memory 1120. The processor 1110 executes the computer program to perform any one of the method steps 1131 according to the disclosure.

A computer-readable storage medium is provided according to an embodiment of the present disclosure. Referring to FIG. 4, the computer-readable storage medium includes a storage unit for program codes, the storage unit is provided with a program 1131′ for performing the method steps according to the disclosure. The program is executed by a processor.

A computer program product including instructions is provided according to an embodiment of the present disclosure. The computer program product, when run on a computer, causes the computer to perform the method steps according to the disclosure.

In the foregoing embodiments, implementation may be entirely or partially performed by using software, hardware, firmware or any combination thereof. When the embodiments are implemented by using software, all or some of the embodiments may be implemented in a form of a computer program product. The computer program product includes one or more computer instructions. When the computer program instructions are loaded and executed in a computer, all or some of the processes or functions according to the embodiments of the present disclosure are implemented. The computer may be a general-purpose computer, a special-purpose computer, a computer network, or another programmable apparatus. The computer instructions may be stored in a computer readable storage medium or may be transmitted from a computer readable storage medium to another computer readable storage medium. For example, the computer instructions may be transmitted from a website, a computer, server, or a data center to another website, computer, server, or data center in a wired (for example, a coaxial cable, an optical fiber, or a digital subscriber line (DSL)) or wireless (for example, infrared, radio, or microwave) manner. The computer readable storage medium may be any available medium capable of being accessed by a computer or may be a data storage device including one or more available medium, such as a server and a data center. The available medium may be a magnetic medium (for example, a floppy disk, a hard disk, or a magnetic tape), an optical medium (for example, a DVD), a semiconductor medium (for example, a solid state disk (SSD)), or the like.

Those skilled in the art should further understand that the units and algorithm steps described in examples in combination with the embodiments according to the present disclosure may be implemented by electronic hardware, computer software, or a combination of electronic hardware and computer software. In order to clearly illustrate the interchangeability of hardware and software, details and steps in each example are described in terms of functions in the above description. Whether the functions being implemented by the hardware or by the software depends on applications of the technical solution and design constraint conditions. Those skilled in the art may use different methods to implement the described functions for each particular application, and such implementation should not be regarded as going beyond the scope of the present disclosure.

Those skilled in the art may understand that all or part of the steps in the method of implementing the above embodiments may be completed by instructing the processor through a program, and the program may be stored in a computer-readable storage medium, and the storage medium is non-transitory media, such as random access memory, read only memory, flash memory, hard disk, solid state disk, magnetic tape, floppy disk, optical disc and any combination thereof.

The foregoing shows only some specific embodiments of the present disclosure, but the protection scope of the present disclosure is not limited thereto. Those skilled in the art may easily think of changes or substitutions within the technical scope disclosed in the present disclosure. The changes or substitutions should be encompassed in the protection scope of the present disclosure. Therefore, the protection scope of the present disclosure should be subject to the protection scope of the claims.

What is claimed is:

1. A learning method for visual odometry based on an ORB feature of an image sequence, comprising:
acquiring a plurality of images and forming an original data set based on the plurality of images;
performing ORB feature extraction on each of the plurality of images in the original data set, to extract a first key feature;
performing feature extraction and feature matching on consecutive images in the original data set through a convolutional neural network, to extract a rich second key feature from the consecutive images; and
inputting the first key feature and the rich second key feature extracted from the original data set to a stacked multi-layer long short-term memory for training and learning, to generate and output estimation for the visual odometry.

2. The learning method for visual odometry based on the ORB feature of the image sequence according to claim 1, wherein the step of performing ORB feature extraction on each of the plurality of images in the original data set, to extract the first key feature comprises:
detecting a key point in an input image by using a FAST algorithm, to generate a FAST feature point;
selecting a plurality of points from the input image according to a Harris corner detection operator;
improving noise resistance and rotation invariance by using a Brief descriptor generation algorithm; and
arranging the plurality of images in the original data set according to time stamps to obtain arranged images, and extracting the first key feature from consecutive key frames in the arranged images through an ORB detector.

3. The learning method for visual odometry based on the ORB feature of the image sequence according to claim 2, further comprising:
after the first key feature is extracted from the arranged images, observing a process of the ORB feature extraction by using Lucas-Kanade optical flow, to obtain the first key feature that conforms to the key point of the input image by screening.

4. The learning method for visual odometry based on the ORB feature of the image sequence according to claim 1, wherein the step of acquiring the plurality of images and forming the original data set based on the plurality of images comprises:
simultaneously acquiring a to-be-observed image by two cameras; and
pairing images acquired by the two cameras according to acquiring time instants, to obtain paired images; and
arranging the paired images according to the acquiring time instants, to form the original data set.

5. The learning method for visual odometry based on the ORB feature of the image sequence according to claim 4, wherein a downward convolution layer of a FlowNetCorr-like structure is used as an architecture of the convolutional neural network, and
the step of performing feature extraction and feature matching on the consecutive images in the original data set through the convolutional neural network, to extract the rich second key feature from the consecutive images comprises:
inputting each of a pair of images in the original data set to the downward convolution layer to extract a respective feature; and
matching features of the pair of images and continuously extracting motion information from the consecutive images, to extract the rich second key feature.

6. The learning method for visual odometry based on the ORB feature of the image sequence according to claim 5, wherein
the stacked multi-layer long short-term memory (LSTM) comprises a plurality of LSTM layers, each LSTM layer of the plurality of LSTM layers is provided with a forget gate, a bias parameter of the forget gate is randomly initialized, an activation function used in each LSTM layer is a linear activation function, each LSTM layer further comprises a storage unit for preventing gradients from disappearing, and
the step of inputting the first key feature and the rich second key feature extracted from the original data set to the stacked multi-layer long short-term memory for training and learning, to generate and output the estimation for the visual odometry comprises:
synthesizing the first key feature and the rich second key feature, and predicting pose information in a current state based on pose information in a previous state, to generate the estimation for the visual odometry.

7. A learning device for visual odometry based on an ORB feature of an image sequence, the learning device comprising:
an image acquiring module, configured to acquire a plurality of images by using a camera and form an original data set based on the plurality of images;
an ORB feature extraction module, configured to perform ORB feature extraction on each of the plurality of images in the original data set, to extract a first key feature;
a convolutional neural network training module, configured to perform feature extraction and feature matching on consecutive images in the original data set through a convolutional neural network, to extract a rich second key feature from the consecutive images; and
a long short-term memory training module, configured to input the first key feature and the rich second key feature extracted from the original data set to a stacked multi-layer long short-term memory for training and learning, to generate and output estimation for the visual odometry.

8. The learning device for visual odometry based on the ORB feature of the image sequence according to claim 7, wherein the ORB feature extraction module being configured to perform ORB feature extraction on each of the plurality of images in the original data set, to extract the first key feature comprises the ORB feature extraction module being configured to:
detect a key point in an input image by using a FAST algorithm, to generate a FAST feature point;
select a plurality of points from the input image according to a Harris corner detection operator;
improve noise resistance and rotation invariance by using a Brief descriptor generation algorithm;
arrange the plurality of images in the original data set according to time stamps to obtain arranged images, and extract the first key feature from consecutive key frames in the arranged images through an ORB detector; and
after the first key feature is extracted from the arranged images, observe a process of the ORB feature extraction by using Lucas-Kanade optical flow, to obtain the first key feature that conforms to the key point of the input image by screening.

9. The learning device for visual odometry based on the ORB feature of the image sequence according to claim 7, wherein
the image acquiring module is provided with two cameras having a same image acquiring mechanism, the image acquiring module is configured to: pair images acquired by the two cameras according to acquiring time instants, to obtain paired images; and arrange the paired images according to the acquiring time instants, to form the original data set; and
a downward convolution layer of a FlowNetCorr-like structure is used as an architecture of the convolutional neural network, and the convolutional neural network training module being configured to perform feature extraction and feature matching on the consecutive images in the original data set through the convolutional neural network to extract the rich second key feature from the consecutive images comprises the convolutional neural network training module being configured to:
input each of a pair of images in the original data set to the downward convolution layer to extract a respective feature; and match features of the pair of images and continuously extracting motion information from the consecutive images, to extract the rich second key feature.

10. The learning device for visual odometry based on the ORB feature of the image sequence according to claim 7, wherein
the stacked multi-layer long short-term memory (LSTM) comprises a plurality of LSTM layers, each LSTM layer of the plurality of LSTM layers is provided with a forget gate, a bias parameter of the forget gate is randomly initialized, an activation function used in each LSTM layer is a linear activation function, each LSTM layer further comprises a storage unit for preventing gradients from disappearing, and
the long short-term memory training module being configured to input the first key feature and the rich second key feature extracted from the original data set to the stacked multi-layer long short-term memory for training and learning to generate and output the estimation for the visual odometry comprises the long short-term memory training module being configured to:
synthesize the first key feature and the rich second key feature, and predict pose information in a current state based on pose information in a previous state, to generate the estimation for the visual odometry.
